(19) United States
(12) Patent Application Publication
(10) Pub. No.: US 2016/0147378 A1
(43) Pub. Date: May 26, 2016

(54) IMAGE DISPLAY APPARATUS

(71) Applicant: Mitsubishi Electric Corporation, Tokyo (JP)

(72) Inventors: Daisuke KISARA, Tokyo (JP); Yuichi OKANO, Tokyo (JP); Kageyasu MIYAHARA, Tokyo (JP); Tomomi NAKAGAWA, Tokyo (JP); Masayuki KIMURA, Tokyo (JP)

(73) Assignee: Mitsubishi Electric Corporation, Tokyo (JP)

(21) Appl. No.: 14/886,373

(22) Filed: Oct. 19, 2015

(30) Foreign Application Priority Data
Nov. 20, 2014 (JP) 2014-235404

(51) Int. Cl. G06F 3/0481; G06F 3/0488; G06F 3/0484

(52) U.S. Cl. CPC G06F 3/0481; G06F 3/04847; G06F 3/04883

(57) ABSTRACT

An object of the present invention is to provide an image display apparatus that suppresses the load on the CPU and the internal storage and suppresses an increase in stress to the user. The image display apparatus of the present invention includes a display, an internal storage, an interface connectable to an external storage, a receiver, and a controller. The external storage stores at least one piece of image data and at least one piece of thumbnail image data obtained by reducing the image data. The controller switches between a thumbnail display mode in which thumbnail image data transferred from the external storage to the internal storage is displayed on the display and a full screen display mode in which original image data of thumbnail image data is transferred from the external storage to the internal storage and displayed on the display, on the basis of inputs to the receiver.

### BACKGROUND OF THE INVENTION

1. Field of the Invention

The present invention relates to an image display apparatus, and in particular to an image display apparatus for transferring image data from an external storage to an internal storage and displaying the image data.

2. Description of the Background Art

As external storage devices (e.g., SD cards (registered trademark)) increase in capacity, the data size of documents and images to be stored continues to increase.

In this situation, it is difficult for built-in equipment such as image display apparatuses with limited resources including CPUs and internal memories to completely transfer large amounts of text and image data from an external storage device to an internal storage and expand and display such data, in terms of CPU performance and the capacity of the internal storage.

Conventional technology has adopted methods of reducing data compression/decompression time by holding large, medium, and small size images in advance and selecting an optimal size image to be decompressed and displayed depending on the output destination of the image (e.g., paper, liquid crystal screen, etc.) (see Japanese Patent Application Laid-Open No. 2002-259942).

Conventional image display apparatuses with the above-described configuration can shorten the amount of time required to decompress images according to various types of possible display destinations.

However, when there are a large number of images, transferring and expanding the images from the external memory to the internal memory at the time of startup places a heavy load on the image display apparatus and is also dependent on the storage capacity of the internal memory. In addition, in the case of built-in display equipment equipped with a touch panel, the timing and the operation with which a user will request display of an image cannot be predicted in advance and therefore a delay may occur depending on the selected image.

Japanese Patent Application Laid-Open No. 2002-259942 does not refer to the above problem, and thus a high-performance CPU will be required if providing the user with stress-free transfer and expansion of images is considered. An internal storage with a large capacity will also be required.

### SUMMARY OF THE INVENTION

It is an object of the present invention to provide an image display apparatus for transferring image data from an external storage to an internal storage and displaying the image data, and to provide an image display apparatus that suppresses the load on the CPU and the internal storage and suppresses an increase in stress to the user.

The image display apparatus according to the present invention includes a display, an internal storage, an interface connectable to an external storage, a receiver, and a controller. The external storage stores at least one piece of image data and at least one piece of thumbnail image data obtained by reducing the image data. The controller switches between a thumbnail display mode and a full screen display mode on the basis of an input to the receiver, the thumbnail display mode being a mode in which the thumbnail image data that has been transferred from the external storage to the internal storage is displayed on the display, and the full screen display mode being a mode in which the image data, which is original image data of the thumbnail image data, is transferred from the external storage to the internal storage and displayed on the display.

The image display apparatus according to the present invention can transfer text and images and display the transferred text and images on the display without depending on the storage capacity of the internal storage of the image display apparatus even when, for example, the external storage stores a large amount of text and image data. It can also be expected that the processing load during transfer and expansion will be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of an image display apparatus according to a first preferred embodiment;

FIG. 2 illustrates an example of image data;

FIG. 3 illustrates an example of text data;

FIG. 4 is a flowchart of operations performed at the time of startup of the image display apparatus according to the first preferred embodiment;

FIG. 5 is a flowchart of transfer processing performed at the time of startup of the image display apparatus according to the first preferred embodiment;

FIG. 6 is a flowchart of normal operations performed by the image display apparatus according to the first preferred embodiment;

FIG. 7 is a flowchart of a display-mode switching operation performed by the image display apparatus according to the first preferred embodiment;

FIG. 8 illustrates an example of display in a full screen display mode of the image display apparatus according to the first preferred embodiment;

FIG. 9 illustrates an example of display in a thumbnail display mode of the image display apparatus according to the first preferred embodiment;

FIG. 10 illustrates a specific example of display in the thumbnail display mode of the image display apparatus according to the first preferred embodiment;

FIG. 11 is a flowchart of a display-mode switching operation performed by an image display apparatus according to a second preferred embodiment;

FIG. 12 illustrates an example of display in the full screen display mode of the image display apparatus according to the second preferred embodiment;

FIG. 13 illustrates an example of display in the thumbnail display mode of the image display apparatus according to the second preferred embodiment;

FIG. 14 is a flowchart of a display-mode switching operation performed by an image display apparatus according to a third preferred embodiment;

FIG. 15 illustrates an example of display in the full screen display mode of the image display apparatus according to the third preferred embodiment;

FIG. 16 illustrates an example of display in the thumbnail display mode of the image display apparatus according to the third preferred embodiment;

FIG. 17 is a flowchart of a display-mode switching operation performed by an image display apparatus according to a fourth preferred embodiment;

FIG. 18 illustrates an example of display in the full screen display mode of the image display apparatus according to the fourth preferred embodiment;

FIG. 19 illustrates an example of display in the thumbnail display mode of the image display apparatus according to the fourth preferred embodiment;

FIG. 20 is a flowchart of a display-mode switching operation performed by an image display apparatus according to a fifth preferred embodiment;

FIG. 21 illustrates an example of display in the thumbnail display mode of the image display apparatus according to the fifth preferred embodiment;

FIG. 22 is a flowchart of a display-mode switching operation performed by an image display apparatus according to a sixth preferred embodiment; and

FIG. 23 illustrates an example of display in the thumbnail display mode of the image display apparatus according to the sixth preferred embodiment.

### DESCRIPTION OF THE PREFERRED EMBODIMENTS

### First Preferred Embodiment

### Configuration

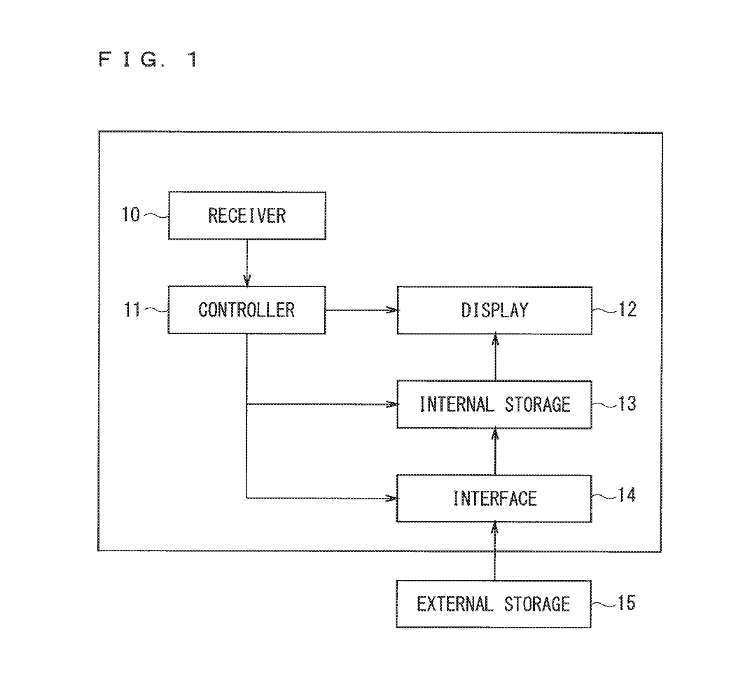

FIG. 1 is a functional block diagram of an image display apparatus according to a first preferred embodiment. The image display apparatus of the present preferred embodiment includes a display 12, a receiver 10, an internal storage 13, an interface 14, and a controller 11.

The receiver 10 includes a touch panel disposed to be superimposed on the display 12. The touch panel detects, for example, that a slider bar or a button displayed on the display has been touched. The internal storage 13 receives image data that is transferred from an external storage 15 connected via the interface 14. The display 12 displays the image data stored in the internal storage 13. The controller 11 controls operations of the internal storage 13, the external storage 15, and the display 12 on the basis of inputs to the receiver 10. For example, the controller 11 switches a display mode (i.e., between a full screen display mode and a thumbnail display mode) on the basis of an input to the receiver 10, and transfers image data from the external storage 15 to the internal storage 13. The controller 11 also expands image data stored in the internal storage 13. And the controller 11 causes the display 12 to display the image data. The display modes will be described later.

The controller 11 is a CPU. The display 12 is, for example, a liquid crystal display. The internal storage 13 is, for example, a video random access memory (VRAM). The external storage 15 is, for example, an SD card (registered trademark), and in this case, the SD card is connectable to the interface 14.

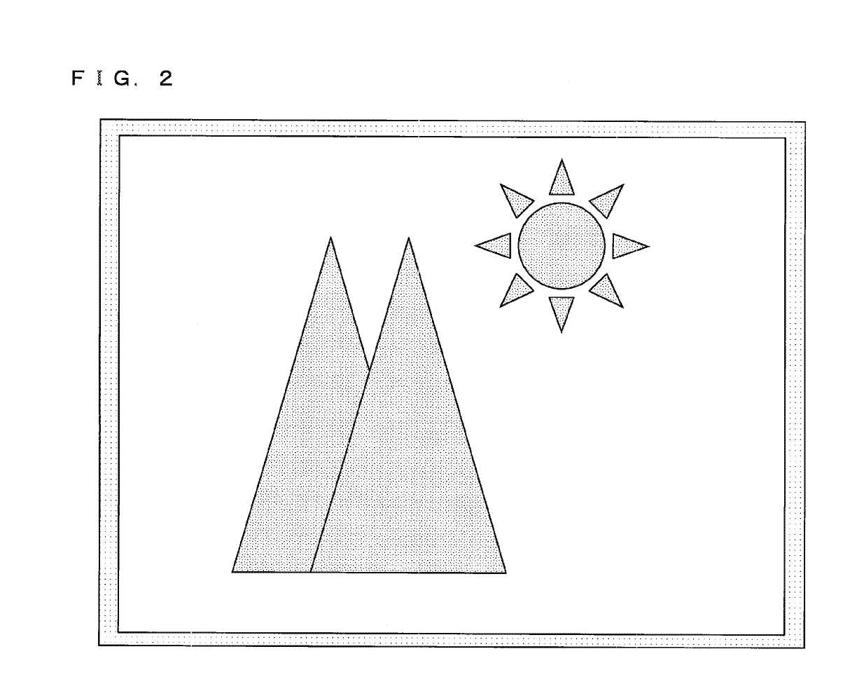

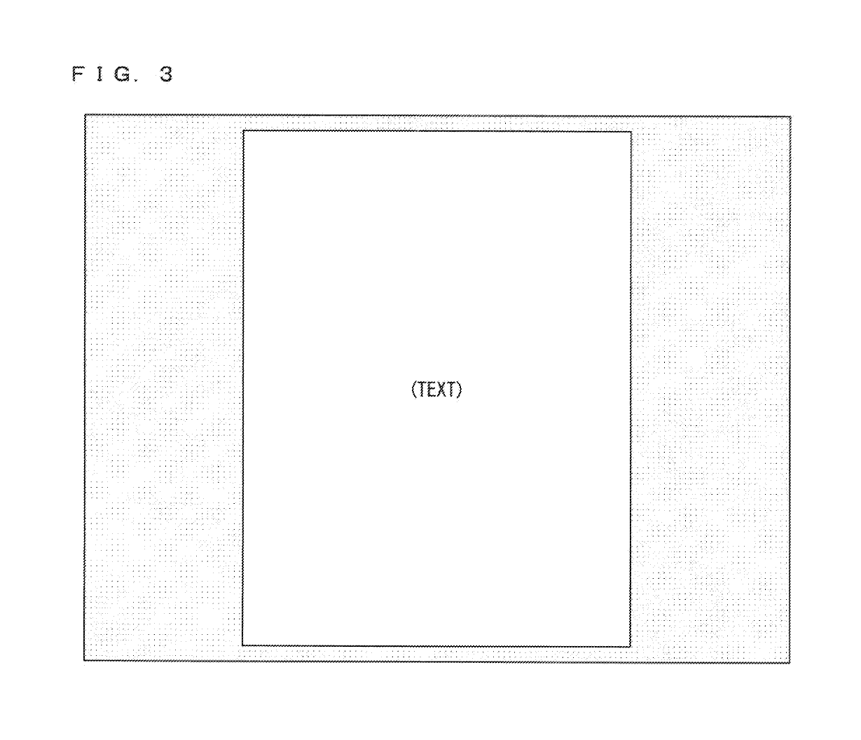

The external storage 15 is assumed to store a plurality of pieces of image data such as illustrated in FIG. 2 in advance. The external storage 15 may also store a plurality of pieces of text data such as illustrated in FIG. 3. The external storage 15 is also assumed to store, in advance, reduced data (referred to as “thumbnail image data”) of each piece of the image data and the text data stored in the external storage 15. Here, the thumbnail image data of the text data refers to a reduced text image based on the text data. Hereinafter, image data and text data are simply referred to as “image data” without distinguishing therebetween. Also, when “image data” is simply referred to, this indicates data of an original size that is not reduced.

### Operations

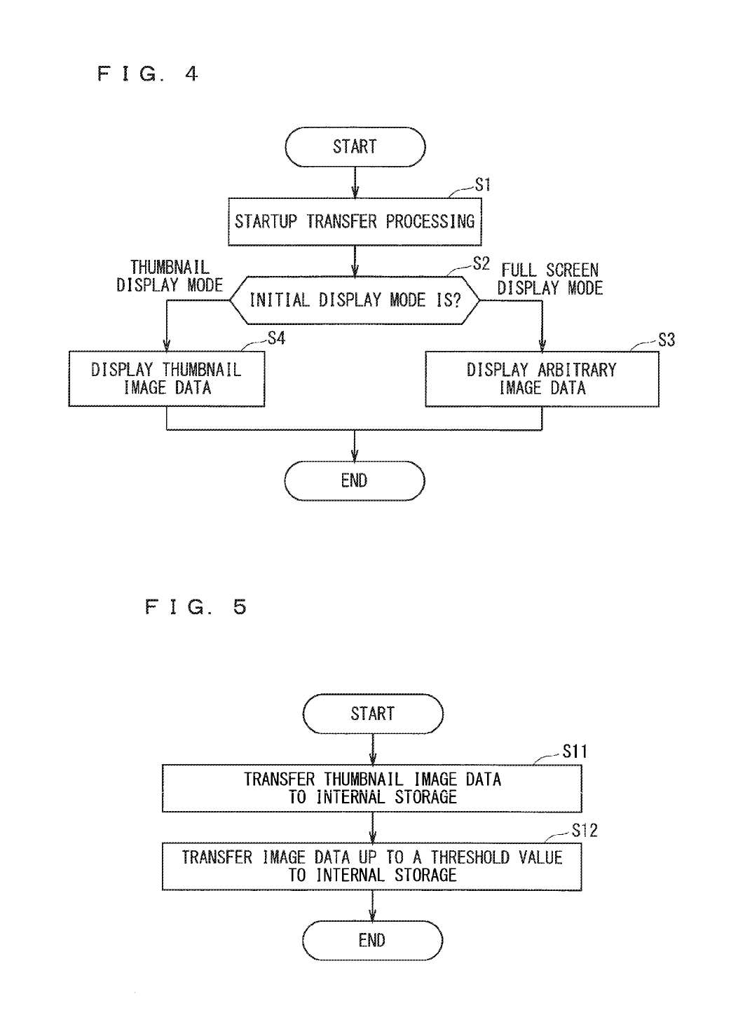

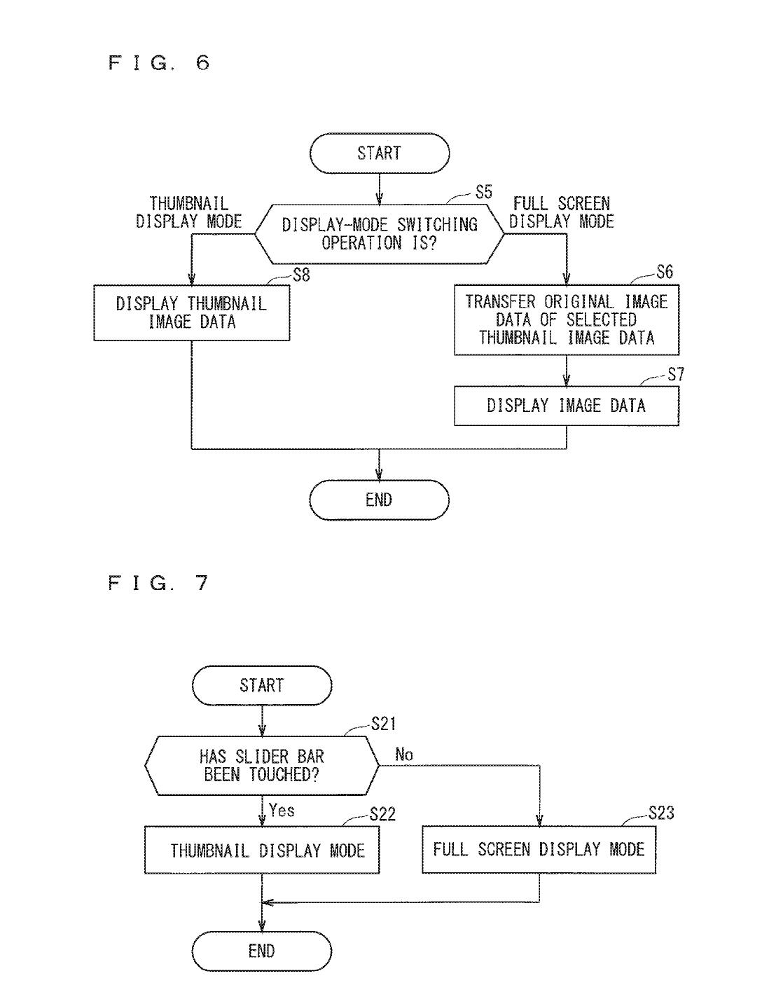

FIG. 4 is a flowchart of operations performed at the time of startup of the image display apparatus according to the present preferred embodiment. FIG. 5 is a flowchart of transfer processing performed at the time of startup of the image display apparatus. FIG. 6 is a flowchart of normal operations performed by the image display apparatus. FIG. 7 is a flowchart of a display-mode switching operation performed by the image display apparatus.

First, the operations performed at the time of startup of the image display apparatus will be described with reference to FIGS. 4 and 5. When the image display apparatus is started up, startup transfer processing is performed (step S1). In the startup transfer processing, the controller 11 first transfers all of the thumbnail image data stored in the external storage 15 to the internal storage 13 (step S11). Next, the controller 11 transfers a predetermined number of pieces of the image data stored in the external storage 15 to the internal storage 13 (step S12).

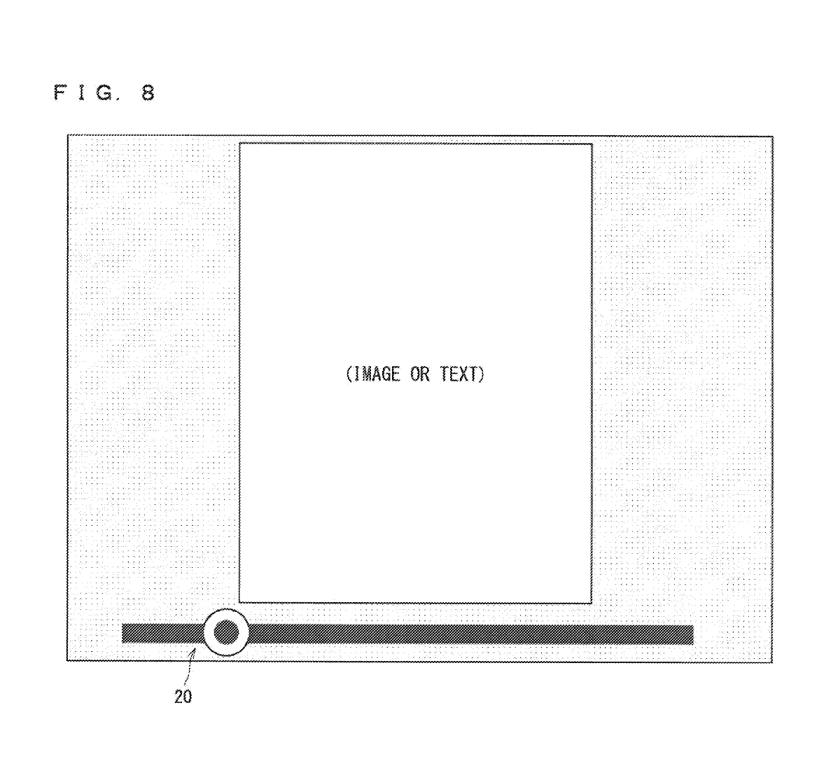

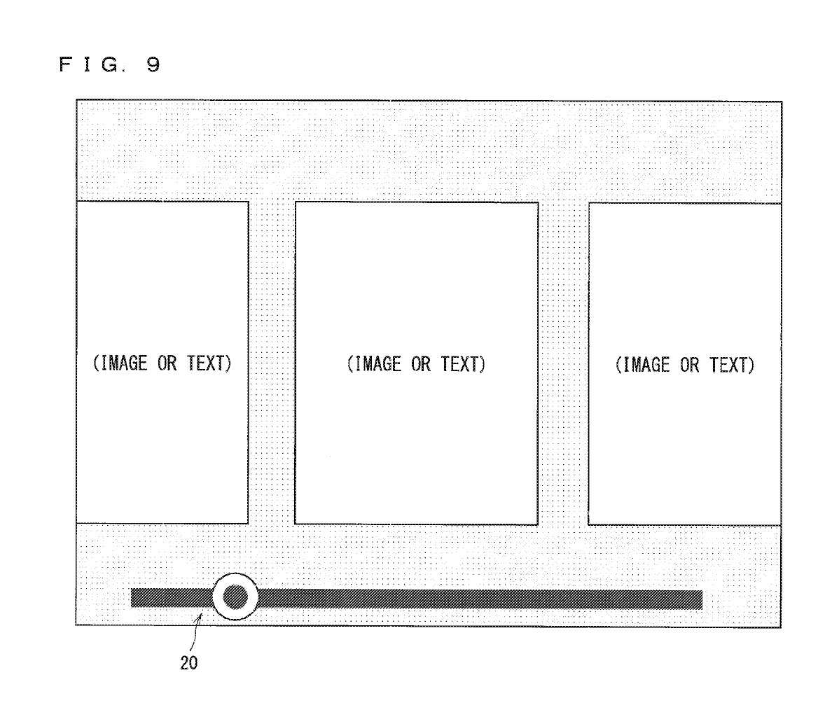

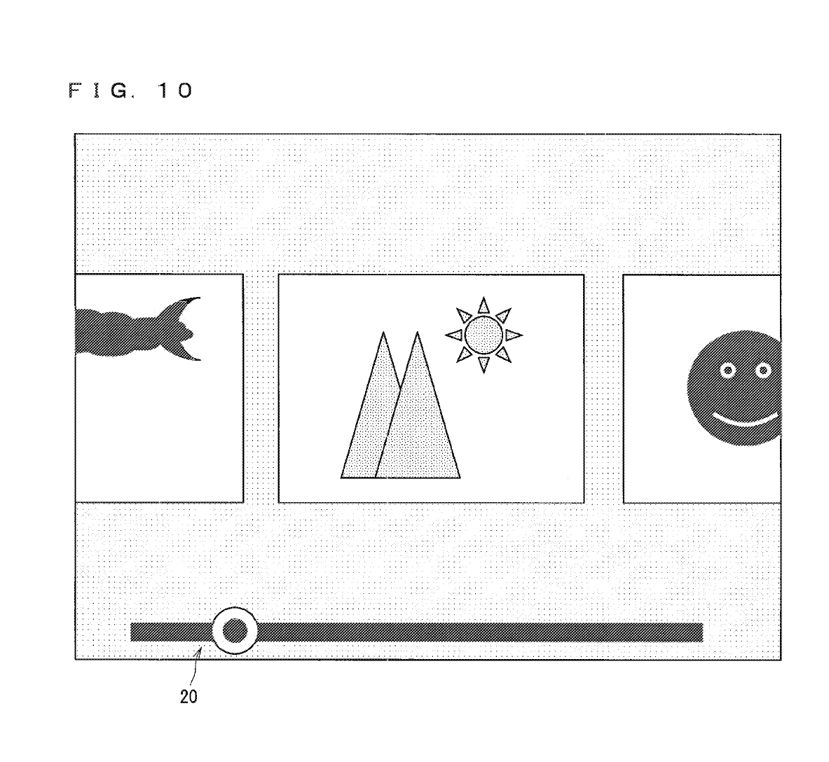

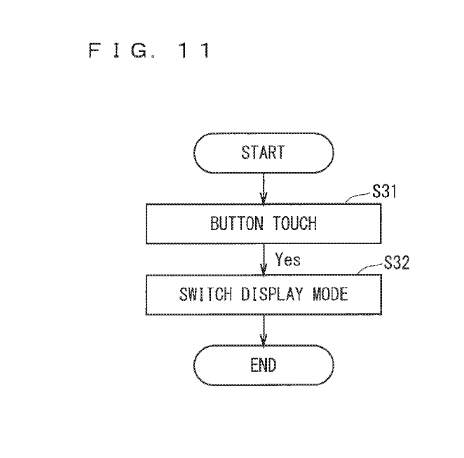

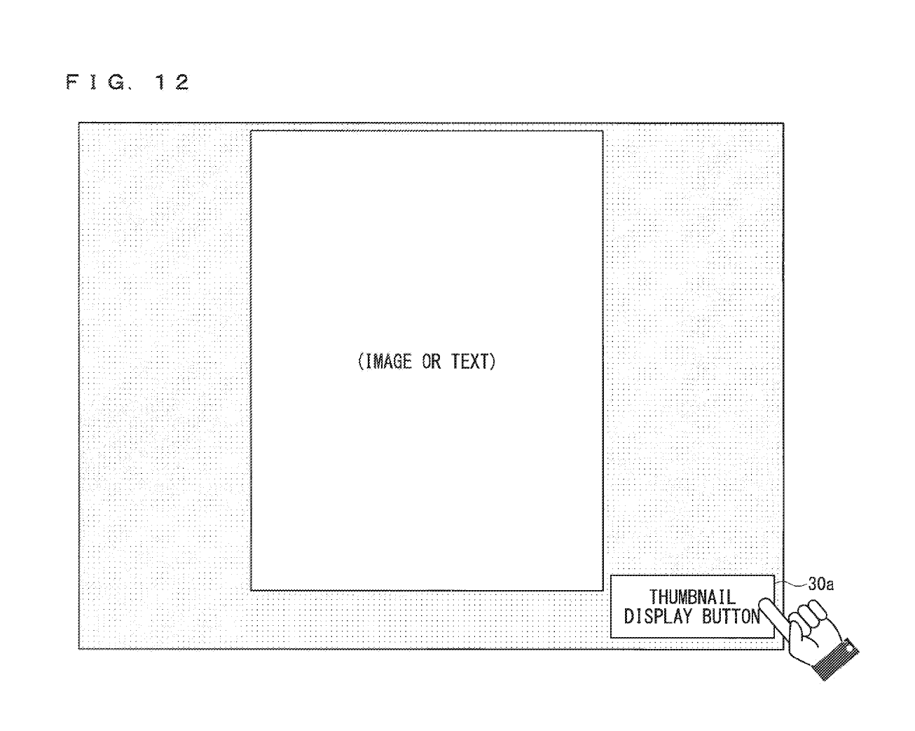

Then, the controller 11 determines whether the initial display mode is the full screen display mode or the thumbnail display mode (step S2). Here, the full screen display mode is a display mode in which image data stored in the internal storage 13 is displayed in large size on the display 12 as illustrated in FIG. 8. The thumbnail display mode is a display mode in which a plurality of pieces of thumbnail image data stored in the internal storage 13 are displayed side by side on the display 12 as illustrated in FIG. 9. Note that FIG. 10 illustrates a specific example of display in the thumbnail display mode.

When the initial display mode is determined to be the full screen display mode in step S2, the controller 11 causes the display 12 to display an arbitrary piece of image data stored in the internal storage 13 as illustrated in FIG. 8 (step S3).

On the other hand, when the initial display mode is determined to be the thumbnail display mode in step S2, the controller 11 causes the display 12 to display a plurality of pieces of thumbnail image data stored in the internal storage 13 as illustrated in FIG. 9 (step S4)

Next, the normal operations of the image display apparatus will be described with reference to FIG. 6. When a display-mode switching operation is input to the receiver 10, the controller 11 determines whether this operation is an operation of switching from the thumbnail display mode to the full screen display mode or an operation of switching from the full screen display mode to the thumbnail display mode (step S5).

When the operation is determined to be the operation of switching to the full screen display mode in step S5, the controller 11 transfers original image data of selected thumbnail image data from the external storage 15 to the internal storage 13 (step S6). The selection of thumbnail image data will be described later. The controller 11 then causes the display 12 to display the transferred image data (step S7). FIG. 8 illustrates an example of display on the display 12 at this time. Note that if the occupancy ratio of the internal storage 13 is low or if the size of a single piece of image data is relatively small compared to the capacity of the internal storage 13, original image data of thumbnail image data that is displayed before and after the selected thumbnail image data may be transferred simultaneously in step S6.

On the other hand, when the operation is determined to be the operation of switching to the thumbnail display mode in step S5, the controller 11 causes the display 12 to display the thumbnail image data stored in the internal storage 13. FIG. 9 illustrates an example of display on the display 12 at this time.

The display-mode switching operation will now be described with reference to FIG. 7. As illustrated in FIGS. 8 and 9, it is assumed in the first preferred embodiment of the present invention that the controller 11 causes the display 12 to display a slider bar 20. The slider bar 20 is used to switch the display mode. In the thumbnail display mode, a user is able to slide and sequentially display a plurality of thumbnail images by touching the slider bar 20.

In the flowchart in FIG. 7, the controller 11 first determines whether or not the slider bar 20 has been touched (step S21). When it is determined that the slider bar 20 has been touched, the controller 11 switches from the full screen display mode to the thumbnail display mode (step S22) and performs the processing of step S8 in FIG. 6.

On the other hand, when it is determined in step S21 that the slider bar 20 has not been touched, the controller 11 switches to the full screen display mode if the current display mode is the thumbnail display mode (step S23) and performs the processing of steps S6 and S7 in FIG. 6. If the current display mode is the full screen display mode, the controller 11 maintains the current display mode.

Note that the controller 11 assumes that the thumbnail image displayed on the center of the display 12 when the thumbnail display mode is switched to the full screen display mode is the selected thumbnail image.

### Advantageous Effects

The image display apparatus according to the first preferred embodiment of the present invention includes the display 12, the internal storage 13, the interface 14 connectable to the external storage 15, the receiver 10, and the controller 11. The external storage 15 stores at least a single piece of image data and at least a single piece of thumbnail image data that is obtained by reducing the image data. The controller 11 switches between the thumbnail display mode in which thumbnail image data that has been transferred from the external storage 15 to the internal storage 13 is displayed on the display 12 and the full screen display mode in which original image data of thumbnail image data is transferred from the external storage 15 to the internal storage 13 and displayed on the display 12, on the basis of inputs to the receiver 10.

Thus, image data and a thumbnail image data are stored in advance in the external storage 15, and when a thumbnail image is selected, the selected image data is transferred from the external storage 15 to the internal storage 13. Through this operation, the size of data that is transferred at one time can be reduced even when the external storage 15 stores a large amount of image data. Thus, the occupancy ratio of the internal storage 13 and the transfer processing load can be suppressed in built-in equipment such as an image display apparatus having limited resources. Suppressing the occupancy ratio of the internal storage 13 and the transfer processing load can suppress delays in the response to operations by the user, and reduce the stress experienced by the user.

In the image display apparatus according to the first preferred embodiment of the present invention, when thumbnail image data displayed on the display 12 is selected on the basis of an input to the receiver 10 in the thumbnail display mode, the controller 11 switches the thumbnail display mode to the full screen display mode, transfers at least a single piece of image data that includes original image data of the selected thumbnail image data from the external storage 15 to the internal storage 13, and causes the display 12 to display the image data.

Thus, the original image data of the selected thumbnail image data is transferred from the external storage 15 to the internal storage 13 only after selection of the thumbnail image data. This allows the occupancy ratio of the internal storage 13 of the image display apparatus to be kept low.

In the image display apparatus according to the first preferred embodiment of the present invention, the controller 11 determines the number of pieces of image data to be transferred at one time from the external storage 15 to the internal storage 13 on the basis of the storage capacity of the internal storage 13 and the size of the image data.

Thus, when the occupancy ratio of the internal storage 13 of the image display apparatus is high, only the single piece of original image data of the selected thumbnail image data is transferred. On the other hand, when the size of the single piece of image data is relatively small or when the occupancy ratio of the internal storage 13 of the image display apparatus is low, original image data of thumbnail image data that is displayed before and after the selected thumbnail image data is also transferred simultaneously, in addition to the original image data of the selected thumbnail image data. Thus, the image display apparatus can operate with an appropriate load based on the capacity of the internal storage 13 and the throughput of the controller 11.

In the image display apparatus according to the first preferred embodiment of the present invention, the controller 11 determines that the thumbnail image data displayed on the center of the display 12 when the receiver 10 receives an input of switching the thumbnail display mode to the full screen display mode is the selected thumbnail image data.

Thus, the thumbnail image data displayed on the center of the display 12 (e.g., a liquid crystal display screen) is selected. This enables the user to select the desired thumbnail image data intuitively.

In the image display apparatus according to the first preferred embodiment of the present invention, the receiver 10 includes the touch panel disposed to be superimposed on the display 12. The controller 11 causes the display 12 to display the slider bar 20 for sliding and sequentially displaying a plurality of pieces of thumbnail image data. The controller 11 maintains the thumbnail display mode while the slider bar 20 is being touched, and when the slider bar 20 is released, the controller 11 switches the thumbnail display mode to the full screen display mode.

Causing the display 12 to display the slider bar 20 and switching the display mode in response to touching of the slider bar 20 enables the user to perform the operation of selecting a thumbnail image and the operation of switching the display mode simultaneously.

### Second Preferred Embodiment

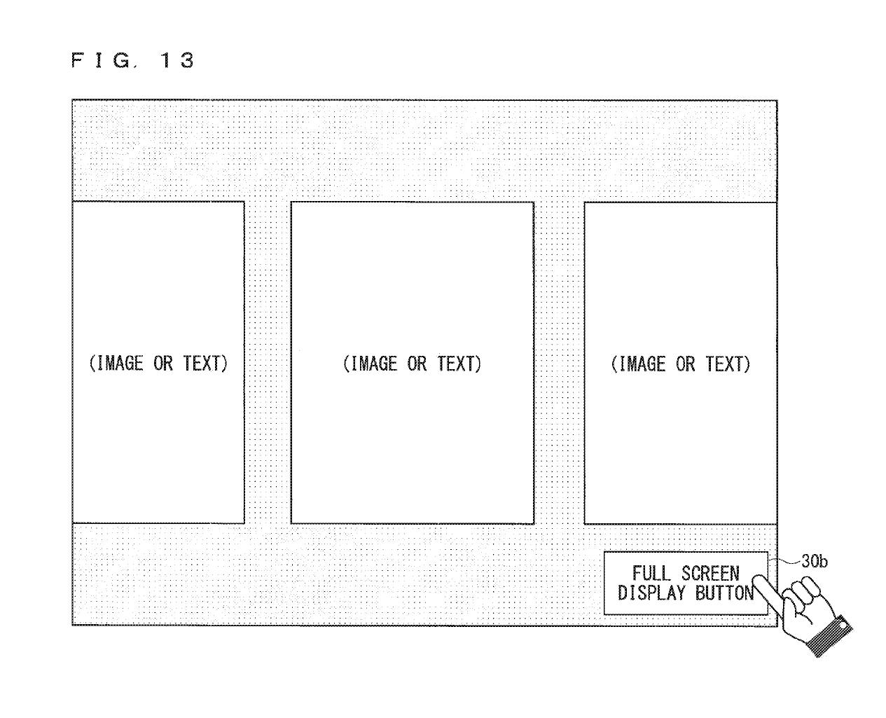

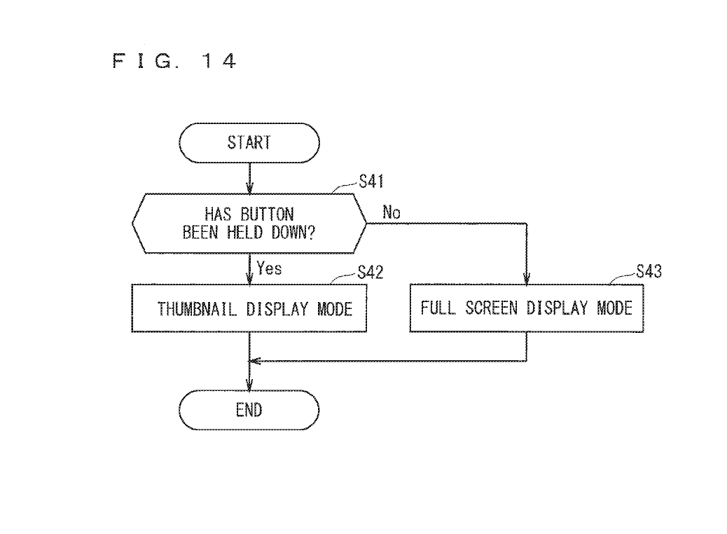

FIG. 11 is a flowchart of a display-mode switching operation performed by an image display apparatus according to a second preferred embodiment of the present invention. FIGS. 12 and 13 respectively illustrate an example of display in the full screen display mode and an example of display in the thumbnail display mode according to the second preferred embodiment of the present invention.

In the first preferred embodiment, the slider bar 20 is used in the display-mode switching operation. In the present preferred embodiment, a button is provided and operated to switch the display mode. The functional block diagram of the image display apparatus according to the second preferred embodiment of the present invention is the same as in FIG. 1, and thus a description thereof has been omitted.

The controller 11 determines whether or not a button displayed on the display 12 has been touched (step S31 in FIG. 11). Here, the button refers to a thumbnail display button 30a (FIG. 12) in the full screen display mode and a full screen display button 30b (FIG. 13) in the thumbnail display mode. When the button has been touched, the controller 11 switches the display mode (step S32).

More specifically, when the touched button is the thumbnail display button 30a, the controller 11 switches the full screen display mode to the thumbnail display mode and performs the processing of step S8 in FIG. 6 as in the first preferred embodiment. When the touched button is the full screen display button 30b, the controller 11 switches the thumbnail display mode to the full screen display mode and performs the processing of steps S6 and S7 in FIG. 6 as in the first preferred embodiment.

### Advantageous Effects

In the image display apparatus according to the second preferred embodiment of the present invention, the receiver 10 includes the touch panel displayed to be superimposed on the display 12. The controller 11 causes the display 12 to display the button (i.e., the thumbnail display button 30a or the full screen display button 30b) and switches between the thumbnail display mode and the full screen display mode in response to touching of the button.

By causing the display 12 to display the special-purpose button for switching the display mode, it is possible to provide a user-friendly user interface.

### Third Preferred Embodiment

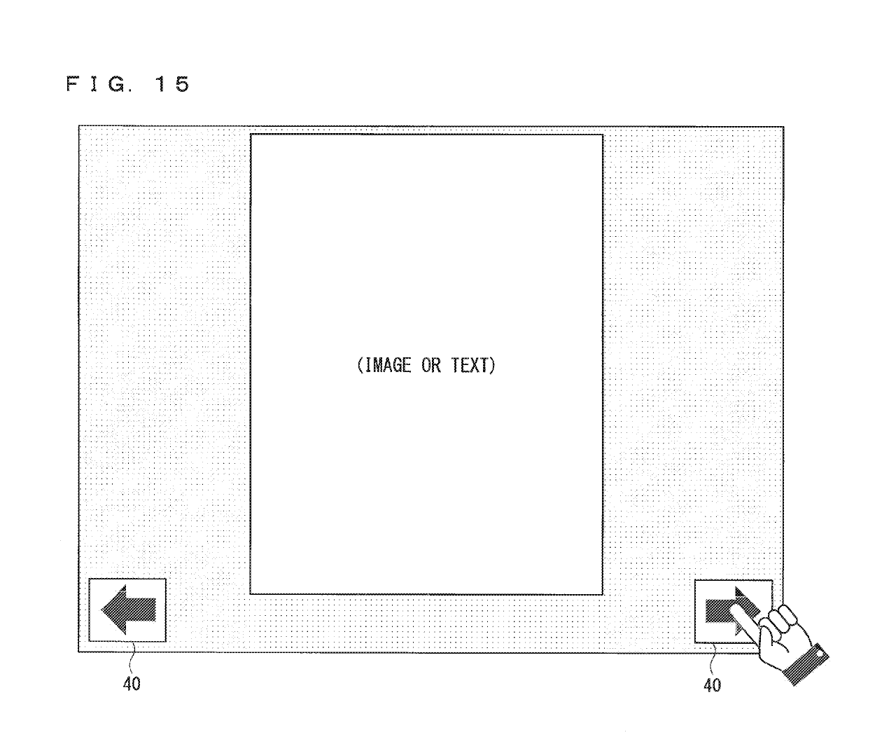

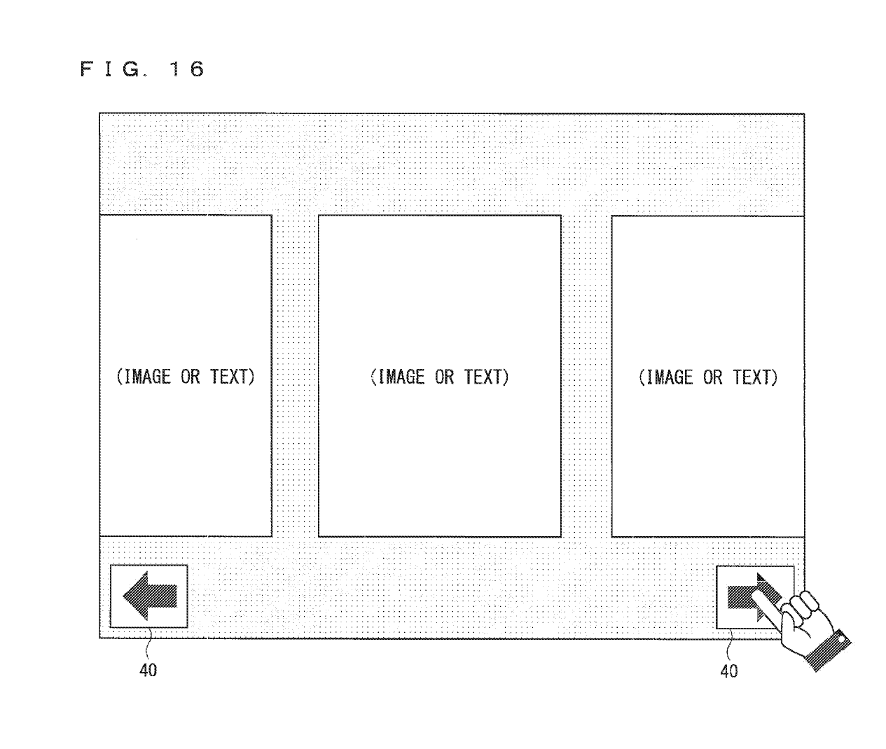

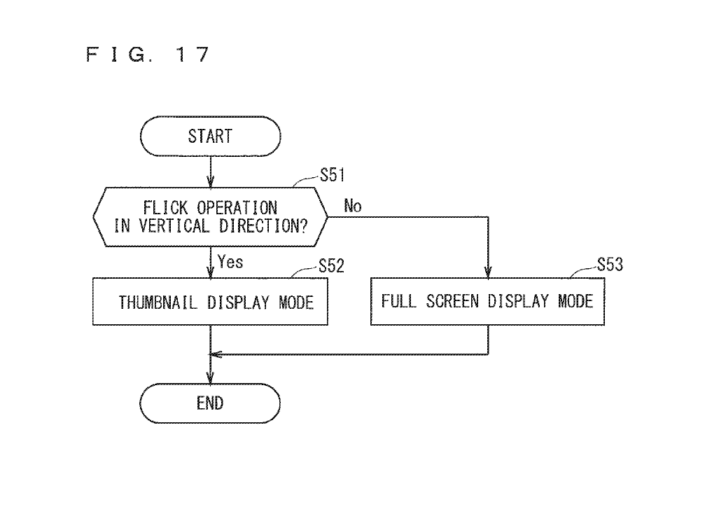

FIG. 14 is a flowchart of a display-mode switching operation performed by an image display apparatus according to a third preferred embodiment of the present invention. FIGS. 15 and 16 respectively illustrate an example of display in the full screen display mode and an example of display in the thumbnail display mode according to the third preferred embodiment of the present invention.

In the second preferred embodiment, the display-mode switching operation is performed in response to touching of a button. In the present preferred embodiment, the display mode is switched according to the length of time that a button remains touched. The functional block diagram of the image display apparatus according to the third preferred embodiment of the present invention is the same as in FIG. 1, and thus a description thereof has been omitted.

The controller 11 determines whether or not a button 40 displayed on the display 12 has been held down (step S41 in FIG. 14). Here, holding down the button 40 refers to an operation in which the button 40 is continuously touched for a predetermined period of time (e.g., one second) or longer.

When it is determined in step S41 that the button 40 has been held down, the controller 11 switches the full screen display mode to the thumbnail display mode and performs the processing of step S8 in FIG. 6 as in the first preferred embodiment.

On the other hand, when it is determined in step S41 that the button 40 has not been held down, the controller 11 switches the thumbnail display mode to the full screen display mode and performs the processing of steps S6 and S7 in FIG. 6 as in the first preferred embodiment.

### Advantageous Effects

In the image display apparatus according to the third preferred embodiment of the present invention, the controller 11 switches between the thumbnail display mode and the full screen display mode according to the length of time that the button 40 has been touched.

Thus, the operation performed when the button 40 has been touched for a short time can be differentiated from the operation performed when the button 40 has been touched for a long time. That is, multiple types of operations are possible with a single type of button.

### Fourth Preferred Embodiment

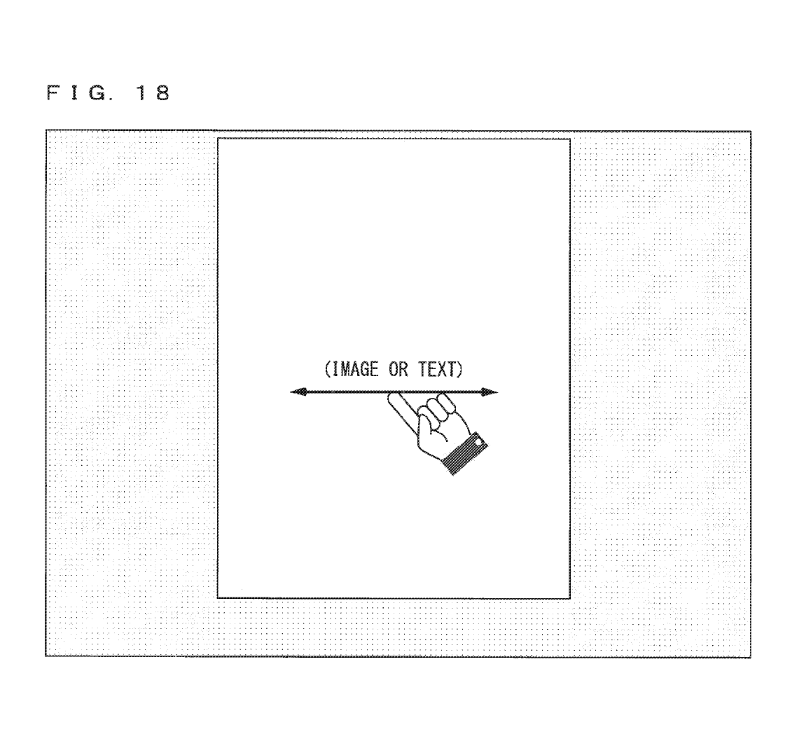

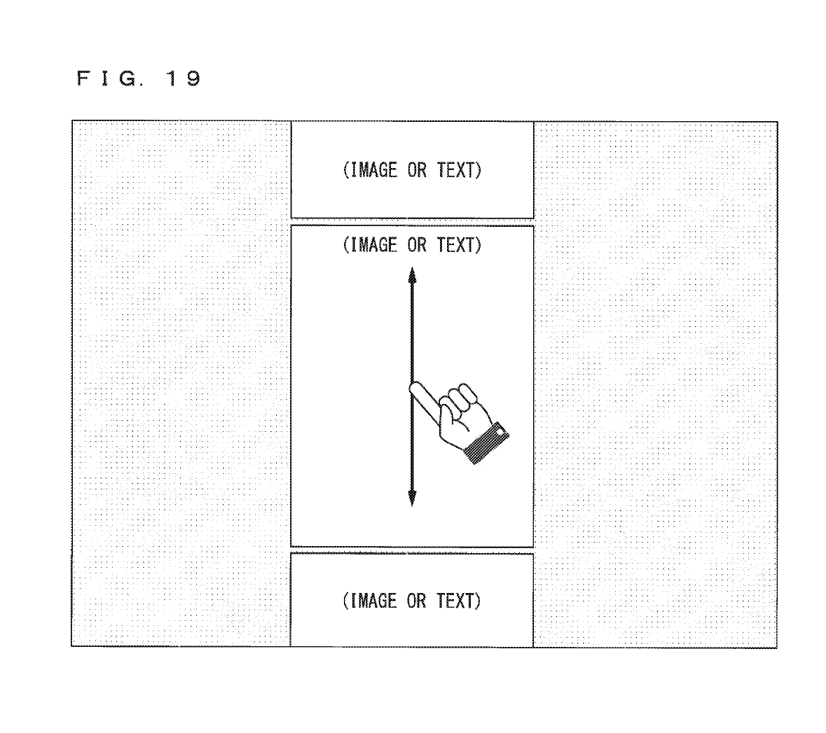

FIG. 17 is a flowchart of a display-mode switching operation performed by an image display apparatus according to a fourth preferred embodiment of the present invention. FIGS. 18 and 19 respectively illustrate an example of display in the full screen display mode and an example of display in the thumbnail display mode according to the fourth preferred embodiment of the present invention.

In the first to third preferred embodiments, an operation target (a slider bar or a button) is displayed on the display 12 and used in the display-mode switching operation. In the fourth preferred embodiment of the present invention, the display mode is switched in response to a gesture operation on the touch panel of the receiver 10. The functional block diagram of the image display apparatus according to the fourth preferred embodiment of the present invention is the same as in FIG. 1, and thus a description thereof has been omitted.

The gesture operation on the touch panel according to the fourth preferred embodiment of the present invention is a flick operation. The flick operation refers to an operation of touching the touch panel with an indicator such as a finger and quickly moving or flicking the indicator on the touch panel in a certain direction.

When the flick operation is performed on the touch panel, the controller 11 determines whether or not the direction of the flick operation is a vertical direction on the screen (step S51). Note that the vertical direction as used here includes not only the direction that is perfectly vertical but also directions within a range of, for example, plus and minus 30 degrees from the perfectly vertical direction.

When the direction of the flick operation is determined to be the vertical direction in step S51, the controller 11 switches the full screen display mode to the thumbnail display mode (step S52) and performs the processing of step S8 in FIG. 6 as in the first preferred embodiment. In the thumbnail display mode, thumbnail images are slid and sequentially displayed according to the amount of sliding in the flick operation performed in the vertical direction as illustrated in FIG. 19.

On the other hand, when the direction of the flick operation is determined not to be the vertical direction in step S51, the controller 11 switches the thumbnail display mode to the full screen display mode and performs the processing of steps S6 and S7 in FIG. 6 as in the first preferred embodiment. In the full screen display mode, image data is displayed one by one by the flick operation performed in the horizontal direction as illustrated in FIG. 18.

### Advantageous Effects

In the image display apparatus according to the fourth preferred embodiment of the present invention, the receiver 10 includes the touch panel disposed to be superimposed on the display 12, and the controller 11 switches between the thumbnail display mode and the full screen display mode in response to a gesture operation on the touch panel.

Thus, the display mode is switched in response to a gesture operation in the fourth preferred embodiment of the present invention. This eliminates the need for the display 12 to display a button or the like for switching the display mode. Accordingly, it is possible to secure a larger area for displaying image data.

In the image display apparatus according to the fourth preferred embodiment of the present invention, the display mode is switched between the thumbnail display mode and the full screen display mode according to the direction of the gesture operation.

Thus, the display mode is switched according to the direction of a gesture operation (in particular, a flick operation) in the fourth preferred embodiment. This enables the user to switch the display mode intuitively.

In the image display apparatus according to the fourth preferred embodiment of the present invention, the gesture operation is a flick operation.

Since the flick operation is widely used as an operation on touch panels, the user can easily perform operations.

### Fifth Preferred Embodiment

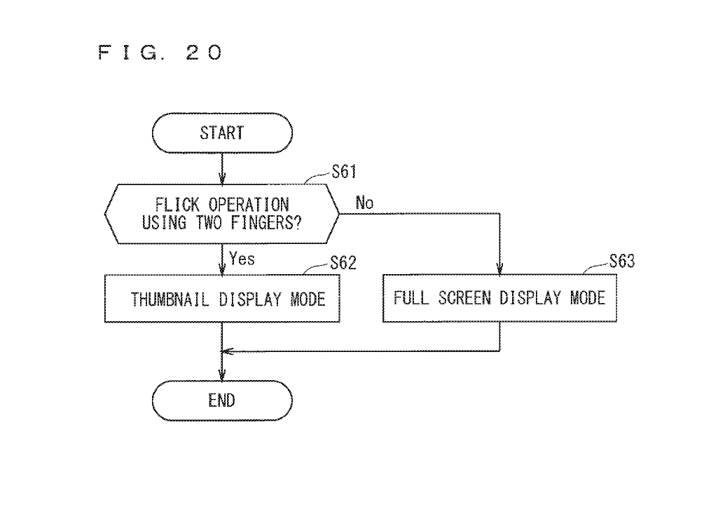

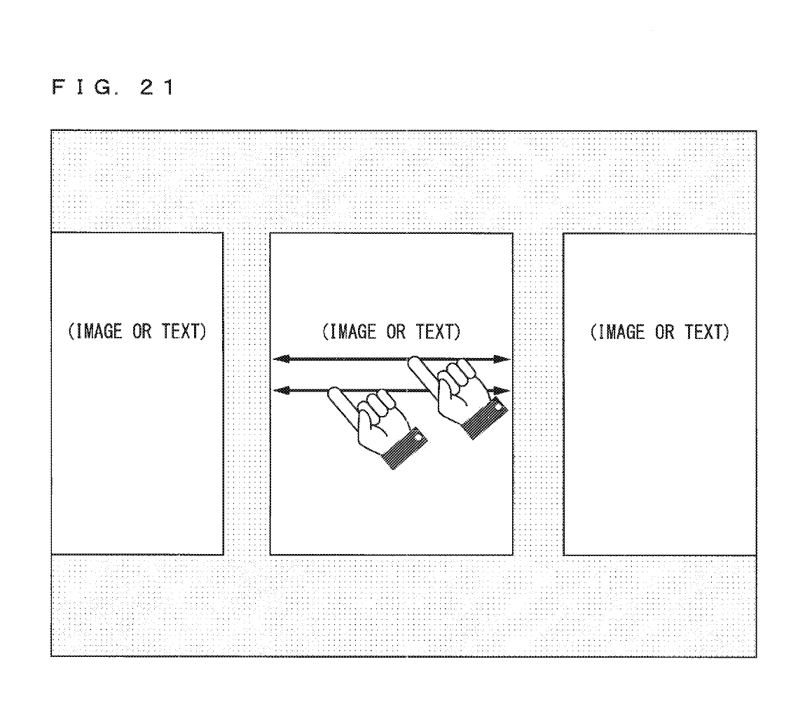

FIG. 20 is a flowchart of a display-mode switching operation performed by an image display apparatus according to a fifth preferred embodiment of the present invention. FIG. 21 illustrates an example of display in the thumbnail display mode according to the fifth preferred embodiment of the present invention.

In the fourth preferred embodiment, the display mode is switched according to the direction of a flick operation on the touch panel. In the fifth preferred embodiment of the present invention, the display mode is switched according to the number of indicators used in the flick operation (i.e., the number of fingers that are touching the touch panel). The functional block diagram of the image display apparatus according to the fifth preferred embodiment of the present invention is the same as in FIG. 1, and thus a description thereof has been omitted.

When a flick operation is performed on the touch panel, the controller 11 determines whether or not the number of indicators used in the flick operation is two (i.e., whether or not two fingers were used in the flick operation) (step S61).

When it is determined in step S61 that two fingers were used in the flick operation, the controller 11 switches the full screen display mode to the thumbnail display mode (step S62) and performs the processing of step S8 in FIG. 6 as in the first preferred embodiment. In the thumbnail display mode, thumbnail images are slid and sequentially displayed according to the amount of sliding in the flick operation with the two fingers as illustrated in FIG. 21.

On the other hand, when it is determined in step S61 that two fingers were not used in the flick operation, the controller 11 switches the thumbnail display mode to the full screen display mode and performs the processing of steps S6 and S7 in FIG. 6 as in the first preferred embodiment. In the full screen display mode, image data is displayed one by one by a flick operation with a single finger as illustrated in FIG. 18.

### Advantageous Effects

The image display apparatus according to the fifth preferred embodiment of the present invention switches between the thumbnail display mode and the full screen display mode according to the number of indicators used in the gesture operation.

Thus, the display mode is switched according to the number of indicators used in a gesture operation (in particular, a flick operation) in the fifth preferred embodiment of the present invention. This enables the user to switch the display mode intuitively.

### Sixth Preferred Embodiment

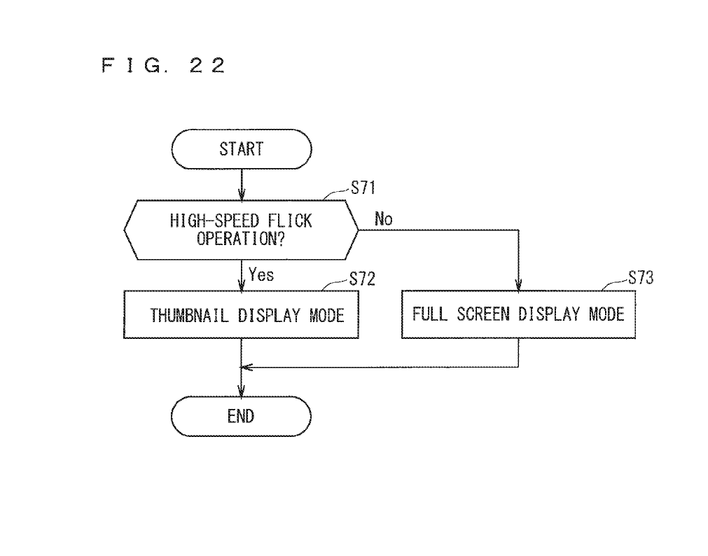

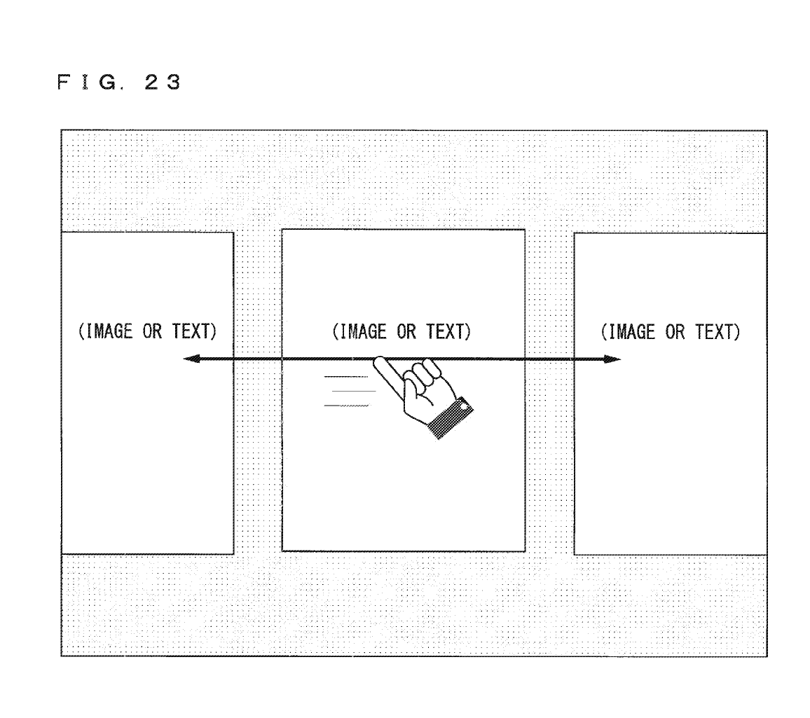

FIG. 22 is a flowchart of a display-mode switching operation performed by an image display apparatus according to a sixth preferred embodiment of the present invention. FIG. 23 illustrates an example of display in the thumbnail display mode according to the sixth preferred embodiment of the present invention.

In the fourth preferred embodiment, the display mode is switched according to the direction of a flick operation on the touch panel. In the fifth preferred embodiment, the display mode is switched according to the number of indicators used in a flick operation on the touch panel. In the sixth preferred embodiment of the present invention, the display mode is switched according to the speed of a flick operation. The functional block diagram of the image display apparatus according to the sixth preferred embodiment of the present invention is the same as in FIG. 1, and thus a description thereof has been omitted.

When a flick operation is performed on the touch panel, the controller 11 determines whether or not the flick operation has been performed at a high speed (step S71). Here, a high-speed flick operation refers to an operation in which the sliding speed of an indicator used in the flick operation exceeds a predetermined threshold value.

When it is determined in step S71 that the flick operation was performed at a high speed, the controller 11 switches the full screen display mode to the thumbnail display mode (step S62) and performs the processing of step S8 in FIG. 6 as in the first preferred embodiment. In the thumbnail display mode, thumbnail images are slid and sequentially displayed according to the amount of sliding in the high-speed flick operation as illustrated in FIG. 23.

On the other hand, when it is determined in step S71 that the flick operation was not performed at a high speed, the controller 11 switches the thumbnail display mode to the full screen display mode and performs the processing of steps S6 and S7 in FIG. 6 as in the first preferred embodiment. In the full screen display mode, image data is displayed one by one by a low-speed flick operation as illustrated in FIG. 18.

### Advantageous Effects

The image display apparatus according to the sixth preferred embodiment of the present invention switches between the thumbnail display mode and the full screen display mode according to the speed of the gesture operation.

Thus, the display mode is switched according to the speed of the gesture operation (in particular, a flick operation) in the sixth preferred embodiment of the present invention. This enables the user to switch the display mode intuitively.

While the above-described examples of the display-mode switching operation are conceivable according to the present invention, the present invention is not limited to the above examples and affects the overall operations performed on the touch panel. Also, apart from a touch panel, a physical button, for example, may be used in the display-mode switching operation.

Note that there may be only a single display component to be displayed on the screen for the display-mode switching operation, or there may be multiple display components. In either case, the switching operation is possible. There are no limitations on the number of images that can be displayed at one time on the screen.

Note that each preferred embodiment of the present invention can be freely combined with any other preferred embodiment and can be appropriately modified or omitted within the scope of the invention.

While the invention has been shown and described in detail, the foregoing description is in all aspects illustrative and not restrictive. It is therefore to be understood that numerous modifications and variations can be devised without departing from the scope of the invention.

What is claimed is:

1. An image display apparatus comprising:
a display;
an internal storage;
an interface connectable to an external storage;
a receiver; and
a controller,
wherein said external storage stores at least one piece of image data and at least one piece of thumbnail image data obtained by reducing said image data, and
said controller switches between a thumbnail display mode and a full screen display mode on the basis of an input to said receiver, said thumbnail display mode being a mode in which said thumbnail image data that has been transferred from said external storage to said internal storage is displayed on said display, and said full screen display mode being a mode in which said image data, which is original image data of said thumbnail image data, is transferred from said external storage to said internal storage and displayed on said display.

2. The image display apparatus according to claim 1, wherein
when said thumbnail image data displayed on said display is selected on the basis of an input to said receiver in said thumbnail display mode, said controller switches said thumbnail display mode to said full screen display mode, transfers at least one piece of said image data that includes said image data, which is original image data of said selected thumbnail image data, from said external storage to said internal storage, and causes said display to display said image data.

3. The image display apparatus according to claim 1, wherein
said controller determines the number of said image data to be transferred at one time from said external storage to said internal storage, on the basis of a storage capacity of said internal storage and a size of said image data.

4. The image display apparatus according to claim 2, wherein
said controller determines that said thumbnail image data displayed on the center of said display when said receiver receives an input of switching said thumbnail display mode to said full screen display mode is said selected thumbnail image data.

5. The image display apparatus according to claim 1, wherein
said receiver includes a touch panel that is disposed to be superimposed on said display,
said controller causes said display to display a slider bar for sliding and sequentially displaying a plurality of pieces of said thumbnail image data,
said controller maintains said thumbnail display mode while said slider bar is being touched, and
said thumbnail display mode is switched to said full screen display mode when said slider bar is released.

6. The image display apparatus according to claim 1, wherein
said receiver includes a touch panel that is disposed to be superimposed on said display,
said controller causes said display to display a button, and
said controller switches between said thumbnail display mode and said full screen display mode in response to touching of said button.

7. The image display apparatus according to claim 6, wherein
said controller switches between said thumbnail display mode and said full screen display mode according to a length of time that said button has been touched.

8. The image display apparatus according to claim 1, wherein
said receiver includes a touch panel that is disposed to be superimposed said display, and
said controller switches between said thumbnail display mode and said full screen display mode according to a gesture operation on said touch panel.

9. The image display apparatus according to claim 8, wherein
said thumbnail display mode and said full screen display mode are switched according to a direction of said gesture operation.

10. The image display apparatus according to claim 8, wherein
said thumbnail display mode and said full screen display mode are switched according to the number of indicators that are used in said gesture operation.

11. The image display apparatus according to claim 8, wherein
said thumbnail display mode and said full screen display mode are switched according to a speed of said gesture operation.

12. The image display apparatus according to claim 8, wherein
said gesture operation is a flick operation.
